(19) United States
(12) Patent Application Publication
(10) Pub. No.: US 2024/0375218 A1
(43) Pub. Date: Nov. 14, 2024

(54) METHOD FOR DEPOSITING MOLTEN METAL FILAMENT USING A LASER BEAM SWEPT ACROSS THE SURFACE OF THE WORKPIECE

(71) Applicant: INDUSTRIALISATION DES RECHERCHES SUR LES PROCEDES ET LES APPLICATIONS DU LASER, ILLKIRCH-GRAFFENSTADEN (FR)

(72) Inventors: Dider Boisselier, Plobsheim (FR); Jérôme Wursthorn, Reichstett (FR); Julien Willauer, Strasbourg (FR); Zakaria Mahfoud, Strasbourg (FR); Thibault Reifsteck, Hultehouse (FR)

(21) Appl. No.: 18/690,646

(22) PCT Filed: Sep. 9, 2022
(86) PCT No.: PCT/FR2022/051708

§ 371 Date: Mar. 8, 2024

(30) Foreign Application Priority Data
Sep. 9, 2021 (FR) FR2109444

(51) Int. Cl. B23K 26/342; B23K 26/082; B23K 26/12; B23K 26/14; B33Y 10/00; B33Y 30/00; B33Y 70/00

(52) U.S. Cl. CPC B23K 26/342; B23K 26/082; B23K 26/123; B23K 26/1464; B33Y 10/00; B33Y 30/00; B33Y 70/00

(57) ABSTRACT

An additive manufacturing method involves commanding movement across the surface of a workpiece of an equipment item comprising a laser, of which the beam is focused on the outlet of a supply head that delivers a metallic wire. The equipment item is caused to move the zone of interaction of the laser beam with the wire along a main path representative of the geometry of the workpiece being manufactured. The movement of the zone of interaction is modulated by 2-axis modulation in a longitudinal direction parallel to the main path and a transverse direction normal to the main path in the focal plane. The deviation defines a curve swept at a speed greater than a speed of travel along the main path. The 2-axis modulation is controlled by a control system comprising means for entering the parameters, for each manufacture, of the control law used for the 2-axis modulation.

### CROSS REFERENCE TO RELATED APPLICATIONS

This application is a national phase entry under 35 U.S.C. § 371 of International Patent Application PCT/FR2022/051708, filed Sep. 9, 2022, designating the United States of America and published as International Patent Publication WO 2023/037083 A1 on Mar. 16, 2023, which claims the benefit under Article 8 of the Patent Cooperation Treaty to French Patent Application Serial No. FR2109444, filed Sep. 9, 2021.

### TECHNICAL FIELD

The present disclosure relates to the field of the DED-Wire (Directed Energy Deposition-Wire) additive manufacturing, which involves melting a metallic material in wire form using a concentrated thermal energy (laser, electron beam or electric arc) deposited along a determined path in order to produce beads that are juxtaposed to form a layer. The layers of material are superimposed until the final workpiece is obtained, the geometry of which approaches the final object, but which will, however, require machining.

### BACKGROUND

The term “additive manufacturing” means the construction of a workpiece or product by repeatedly adding layers of material and bonding the new layers to the preceding layers. The examples disclosed may be used to perform additive manufacturing using a wire (e.g., a metal wire, optionally a cored wire, a metal core wire, etc.) as material, melted by the action of the energy of a laser beam, and deposited to form a new layer, which is welded on the previous layer.

The design of a workpiece begins by creating the 3D model using CAD software. The digital model of the workpiece is then divided into a multitude of layers, parallel to one another, by dividing software, called slicer, representing the various layers of material necessary to manufacture the workpiece. The technique consists in depositing material on a plate or component undergoing repair using a nozzle mounted on an arm with several axes (generally 4 to 6). The material that feeds the nozzle is provided in powder or wire form. During deposition, a heat source melts the material simultaneously, generally using a laser, an electron beam, an electric arc or a plasma jet. This procedure is repeated until the layers are solidified and have created or repaired an object.

A laser beam (WLAM method for “Wire Laser Additive Manufacturing”) locally melts the wire.

This technique makes it possible, in particular, to repair or refill damaged metal parts and to construct, by concentrated energy deposition, relatively large parts (a dimension exceeding a meter) that require minimal tooling, are inexpensive and require relatively little post-treatment. DED methods also make it possible to produce components with composition gradients or composite structures consisting of several materials having different compositions and structures.

In the state of the art, U.S. Patent Application Publication No. US2018/021887 discloses a method and an apparatus for performing the treatment for manufacturing a layer of a three-dimensional workpiece with an electron beam, consisting in exposing the raw material to an electron beam to liquefy the raw material; depositing the raw material on a substrate as molten pool deposit, the deposit having a front edge region in a plane x-y with a front edge region width and a rear edge region in the plane x-y with a rear edge region width under at least a first treatment condition; monitoring the molten pool deposit for at least one preselected condition by detecting dispersion from a modulation electron beam simultaneously with the deposition step; automatically modifying the first treatment condition to be a different treatment condition based on information obtained from the comparison step; and repeating the steps at one or more second locations for building a three-dimensional workpiece layer by layer, globally along an axis z that is orthogonal to the plane x-y.

This prior art document provides an oscillating laser beam performing welding by advancing on the joint not in a fixed beam path, but by moving the path of the beam around the central line as the beam advances. In one example, the laser beam is rotated about a vertical axis.

Japanese Patent Application JP2019155376 discloses an additive manufacturing apparatus proposing to inject three materials in wire form. Paragraph specifies that a rotary prism drives the beam in rotation to irradiate each of the three metal materials in wire form.

Also known is U.S. Pat. No. 9,095,928, which discloses a system that directs a first laser beam onto a surface of a workpiece to create a molten pool on the surface, and a wire feed device that advances a non-durable article to the molten pool so that the non-durable article comes into contact with the molten pool. This system comprises a second laser beam system that directs a second laser beam onto the non-durable article before the non-durable article penetrates the pool, and a control device that controls an output of the electrical power supply and the second laser beam system.

European Patent EP3263269 relates to a welding or refilling apparatus wherein one or more energy beam emitters are used to generate a wide beam spot transverse to a welding or recharging path, and one or more reels supply the wire to the point to create a wide weld bead.

The solutions of the prior art are not completely satisfactory because the local material deposition conditions are not constant and stable from a thermal and geometric point of view, which leads to direct consequences on the quality of the fusion between the consecutive layers. This problem is encountered in configurations where the movement along the main path has speed variations leading to areas of overheating or lack of energy and partial fusion, but also based on the alignment of the wire(s) with respect to the direction of the main path. For manufacturing a workpiece by additive deposition of fuse wire, this leads to the appearance of geometric or metallurgical defects, which can be amplified layer after layer, or which lead to localized weak points.

The prior art documents propose solutions where the laser beam is deflected by a scanner modifying the direction of the laser beam for an oscillating path.

### BRIEF SUMMARY

In a general sense, the present disclosure relates to an additive manufacturing method in which a laser beam is focused on the outlet of a supply head that delivers at least one metallic wire.

The method involves commanding the movement across the surface of a workpiece of an equipment item comprising at least one laser, of which the beam is focused on the outlet of a supply head that delivers at least one metallic wire of diameter D, the equipment item being made to move the zone of interaction of the laser beam with the at least one wire along a main path representative of the geometry of the workpiece being manufactured, wherein the movement of the zone of interaction is modulated by 2-axis modulation in a longitudinal direction parallel to the speed vector of the main path and a transverse direction normal to the speed vector in the focal plane, the deviation defining a curve swept at a speed greater than the speed of travel along the main path, the 2-axis modulation being controlled by a control system comprising means for entering the parameters, for each manufacture, of the control law used for this 2-axis modulation.

Preferably, the axis of the supply head of the wire forms an angle between 5° and 40° with the axis of the laser beam.

According to an alternative, the supply head of the filler wire comprises a plurality of filler wire outlets converging toward a zone of interaction corresponding to the intersection between the 2-axis modulation of the beam and the surface of the workpiece whereupon the bead is deposited.

According to another alternative, at least two wires are injected into the zone of interaction.

Advantageously, the control system is based on a logic controller and a digital control and controls a modulation of the laser beam and a modulation on the various injected wires.

According to a particular embodiment, the at least one metal wire comprises at least two different materials.

According to another embodiment, the movement of the zone of interaction is controlled to ensure preheating upstream of the molten pool using the beam not absorbed by the wires.

Advantageously, the movement of the zone of interaction is modulated by the 2-axis modulation according to a shape adapted to the injection of the filler wires so as to ensure the preheating of the zone comprising the wire and the workpiece upstream of the molten pool, the melting of the filler wire(s) as well as the maintenance of the molten pool.

According to an alternative, the movement of the zone of interaction is modulated by the 2-axis modulation according to a shape determined to act directly during the deposition of material over the width of the molten pool and thus the geometric characteristics of the material deposited.

According to another alternative, at least two filler wires with different chemical compositions are injected.

According to another alternative, at least two filler wires of different diameters are injected.

### BRIEF DESCRIPTION OF THE DRAWINGS

The present disclosure will be better understood on reading the following description, with reference to the appended drawings showing non-limiting embodiments, wherein:

FIG. 1 shows a schematic front view of the installation;

FIG. 2 shows a schematic view of the modulation zone;

FIG. 3 shows a schematic view of the closed curve traveled by the laser beam according to a first alternative;

FIG. 4 shows a schematic view of the closed curve traveled by the laser beam according to a second alternative; and

FIG. 5 shows the diagram for manufacturing a T-shaped test specimen.

### DETAILED DESCRIPTION

The present disclosure aims to facilitate the manufacture, without using a vacuum chamber, of large-sized workpieces, typically several tens or even hundreds of centimeters, by additive manufacturing, and/or the recharging for the repair of damaged parts of such large workpieces, and/or the addition of functional protuberances to workpieces and the performance of welding operations with the addition of material, with a wide range of metal alloys in the form of wire coils, in the open air or under a controlled atmosphere at ambient pressure. These are, in particular, stainless steel wires, low and moderately alloyed steels, titanium alloys, nickel and cobalt superalloys, aluminum alloys as well as copper bases, and typically all materials that are conductive or non-conductive, weldable, from an operating point of view, and available in the form of a wire.

Considering the dimensions of the parts that can be made and the alloys considered, the sectors targeted mainly are aeronautics, space, defense, transportation (including the rail and automotive sectors), energy (including nuclear, renewable energy) and petrochemistry.

Typically, the objective of embodiments of the present disclosure is to allow the manufacture of large parts, at manufacturing speeds greater than 500 cm3/h. This device must make it possible to maintain a regularity of deposition layer after layer owing to high robustness, despite the high speed of construction that can be achieved.

The present disclosure relates more particularly to the fact that the movement of the laser beam is controlled according to a main path, and that this beam is moreover subjected to periodic movements of small amplitude around the median position defined by the main path. It differs from the background art by the fact that this modulation is not constant over the entire path, but that certain characteristics of this modulation vary dynamically to take account of the deposition conditions, which differ based on multiple parameters, in particular, related to the path (radius of curvature, cusp, etc.) and to the specificities of the zone of interaction with the wire and the support (number of wires, local temperature, etc.).

This modulation can be defined beforehand for each zone of the main path, the modifications of the sweeping parameters being controlled based on the position of the laser head on the main path. It can also be dynamically controlled from information provided by a sensor, for example, an optical and/or thermal camera directed toward the zone of interaction of the laser with the fuse wire(s), controlling the changes in the sweeping parameters.

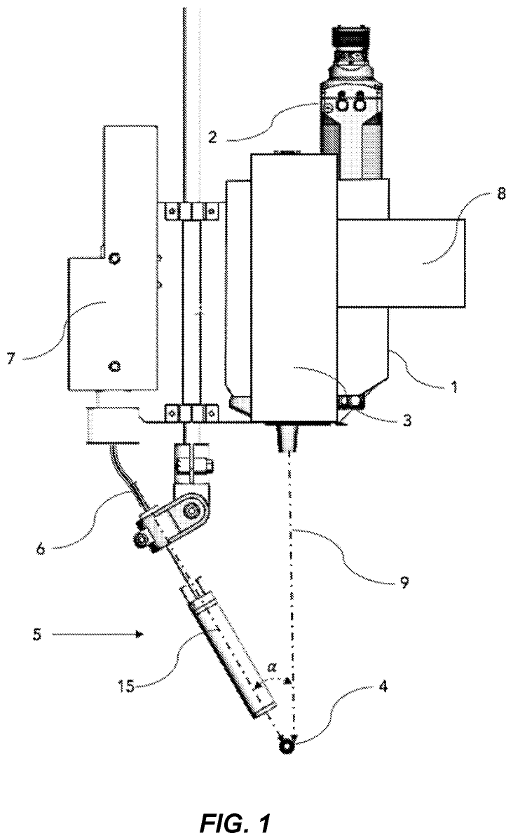

An embodiment of the present disclosure, shown by way of schematic example in FIG. 1, is based on the use of a laser (2), of the fiber laser, disk laser or diode laser type emitting a beam driven by optical fiber to an optical unit (3) producing a focused beam (9) that interacts with a wire (6) injected laterally with respect to the laser beam. This interaction makes it possible to melt this wire owing to the use of a sufficiently high energy density (focused beam).

In the preferred family of configurations, the optical unit (3), which forms the laser beam in such a way that it interacts with the fusible material filler wire(s) and the workpiece whereupon the deposition is carried out, is moved while keeping a given distance (working distance based on the focal length of the optical system) relative to the surface of the workpiece, along a so-called main path (16), according to the layout of the workpiece set by the additive manufacturing or recharging plan, with a local speed V in the plane (14) of the working zone, and over a distance L corresponding to the course of the path set by the manufacturing or recharging plan, while moving the laser beam (9) at the same time and independently of the so-called main path (16), along a median axis (11) that is movable normal to the plane (14) of the working zone, the point of intersection (15) between this axis (11) and this plane (14) being moved on this surface.

The laser beam (9) is further deflected along a periodic path (13) defining a closed curve (13) that is inscribed in a zone of interaction (4) between the laser beam (9) and the wire(s) (6), centered on the axis (11) of the beam (9).

The present disclosure relates to the fact that the characteristics of the periodic modulation path (13) relative to the main path are dynamically adapted based on the local characteristics of the main path. The modulation parameters that are controlled based on the local characteristics of the path relate to one or more of the characteristics comprising:
The nature of the design (in a circle, eight, rectangle, etc.), for example, by selecting in a base of prerecorded designs;
The amplitude of the modulation;
The frequency of the modulation; and
The dimensions of the design.

The local characteristic(s) taken into account to control the modulation comprise:
The direction of movement relative to the wires (6);
The geometry of the path (curved, straight, angle or singular point);
The radius of curvature;
The type of bead (bead alone, abutting an adjacent bead);
The zone of the bead (beginning, end); and
The speed variation of the path.

Different control modes can be implemented:
Either the parameters of the various configurations are identified beforehand and stored in a database. The system analyzes the configurations encountered and uses the preprogrammed parameters based on defined selection criteria.
Or the system can be equipped with sensors that analyze the conditions of the interaction and the deposition geometry to automatically adapt the modulation parameters and the other method parameters.

In both cases, the modulation mode is not constant, but depends on the position on the main path.

The modulation parameters are controlled and adjusted dynamically to favor the beam/wire interaction on certain wires or certain portions of wires rather than others in order to be able to better control and regulate the deposition of material, and counterbalance dissymmetries and instabilities resulting from the type of bead, the direction of movement, etc.

This variation of the modulation parameters is activated during the deposition to take the actual deposition conditions into account in real time.

The adaptation of the modulation parameters, associated with the parameters of the method, makes it possible to:
Optimize beam/wire/substrate coupling;
Ensure better deposition efficiency;
Improve wetting on the edges of the deposit by controlling the energy deposition and its spreading;
Improve remelting on adjacent beads;
Optimize geometric continuity of the material deposit;
Adjust the conditions to the rapid changes in the geometry of the workpiece to be constructed; and
Combat the appearance of defects by stabilizing the beam/material coupling

### INSTALLATION KINEMATICS

The movement of the zone of interaction (4) between the laser beam (9) and the wire (6) (or the wires when the installation provides the supply with several wire injectors) is ensured by a combination of two movements:
A main movement, along a path defined by the configuration of the workpiece to be produced, ensured by a robotic arm or a set of motorized Cartesian axes ensuring the movement of the plate (1) supporting the laser (2), the optical unit (3) and the supply coil as well as the wire supply head (6);
A modulation movement, according to a closed curve, ensured by a galvano-scanner or by a motorized assembly (8) controlling a movement of the laser (2) and of the optical unit (3) relative to the plate (1), along two axes perpendicular to the axis of the laser beam (9).

The main movement is determined by the geometry of the part to be produced, in a known manner from a digital definition file of the workpiece, for example, making it possible to generate the deposition paths of the various layers according to an optimized path.

Prior to the deposition operation, the digital definition of the workpiece is sliced by a multitude of sections parallel to one another. These sections represent the layers of material to be deposited, and the thickness of each one corresponds to the thickness of the beads deposited. In each of these layers, the movement of the deposition head is calculated to cover the surface using juxtaposed beads of material. All these movements are recorded in a file constituting the workpiece program, which is then read by the digital control of the machine, which controls the various motorized axes of the machine.

Typically, the movement speed V of the deposition head is of around a few tens of centimeters per minute, for example, from 0.4 to 0.6 meters per minute. It can reach several meters per minute based on the desired size of the beads.

The second so-called modulation movement is carried out in the vicinity of the melting point of the wire(s), according to a curve, in particular, a closed curve, defined by a controllable shape, with a longitudinal amplitude in the main movement direction, and a transverse amplitude, in the direction perpendicular to the main movement direction, in the plane defined by the layer in formation. Typically, the modulation path has two or more singular points where the speed in the main movement direction is zero. By way of example, the diameter of the wire is between 1 and 4 millimeters, typically 1.6 mm.

This modulation movement has movement sequences in the same direction as the direction of the main movement alternating with movement sequences in the direction opposite the direction of the main movement, to heat the workpiece upstream of the material deposition zone and thus to prime the molten pool, allowing optimized coupling of the energy and the thermal cycle of the method, and making it possible to optimize the temperature cycle at the time of the deposition of material on the workpiece or to maintain the molten pool.

The curve of this modulation movement typically takes the form of an “8” or a circle or any other design shape. This modulation movement is described by the laser beam at an adjustable frequency of several hundred hertz, typically 250 Hz and more generally between 200 and 300 Hz.

The “multiwire” variant of the present disclosure has several applications:
Obtaining a multidirectional deposit, with 3 or 4 wires, to produce a deposition of material in all directions, keeping a beam modulation normal to the deposition surface. Apart from the beam modulation scanner head, this configuration does not require complex optical systems, as is the case with heads using a wire normal to the surface and a coaxial beam or several beams inclined relative to the wire.
Increasing the deposition rate without having to increase the wire speeds, which makes it possible to guarantee more stability for the injection of the wire and the method.
Possibility of using finer wires that melt more easily under the beam.
Addition of material distributed over the molten pool.
Possibility of playing on the speed of advance of each wire based on the direction of movement and on the geometric configuration of the bead of material deposited, in combination with the characteristics of the modulation profile. Thus, the operating conditions on a contour bead or a filler bead will be different and can be optimized by using this option.

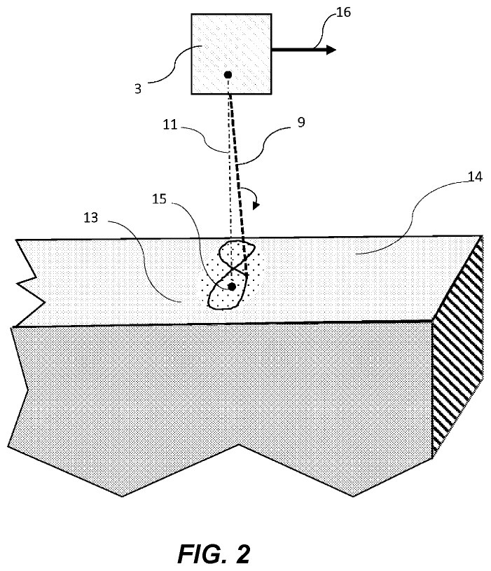

The device according to one example embodiment of the present disclosure shown by FIGS. 1 and 2 consists of a plate (1) actuated by a robotic arm.

This plate (1) supports an optical fiber transporting the laser beam is connected to an optical module comprising a scanner and optics for shaping the beam produced by a high-power laser source (2) (several kW, up to more than 10 KW) associated with an optical unit (3) to focus on the wire at a focal point (4) corresponding to the interaction zone between the laser beam and a metal wire delivered by a supply system (7).

The supply system (7) comprises a controlled motorized system for controlling the advancement of the wire (6) to the injection system (5) with a maximum speed of a few meters per minute, typically 4 to 6 meters per minute or even 10 m/min. It also comprises a nozzle (15) for cooling and diffusing a neutral or inert gas to protect the molten pool from oxidation.

A control system based on the use of a digital control allows the modulation of the beam in the focal plane (4) of the optical system (2, 3) to be controlled by means of a scanner (8) according to a design and a programmed frequency, and allows this assembly to be moved along a programmed path, consisting of juxtaposed beads making it possible to cover the entire surface of the layer.

The function of this modulation is to widen the energy supply zone, by melting the wire (6) during the passage over the zone of interaction (4), while maintaining a molten pool whose width is set by the transverse dimension relative to the direction of advance ensured by the robotic arm.

The amplitude of this modulation, with the system used in the disclosed example, reaches 10 mm, and the designs are produced with a frequency of 250 Hz.

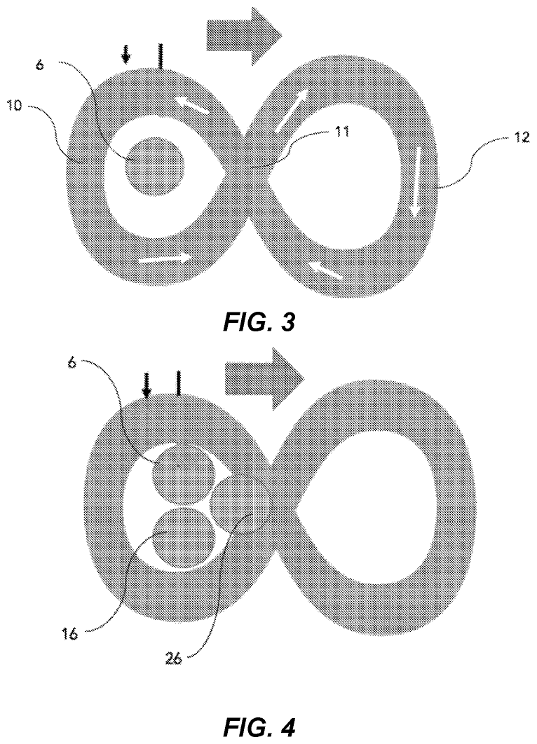

The scanner (8) controls a path in the form of a circle, an 8, an infinity sign or else dashes, having two or three singular points (10 to 12) as shown by FIGS. 3 and 4.

This modulation function also makes it possible to begin to superficially melt the surface of the workpiece upstream of the molten pool where the deposition of the molten wire is carried out and to more precisely delimit the edges of the deposited bead of material.

The wire (6) is injected laterally with respect to the beam (9), with an angle α of about 30° or less. This lateral injection coupled to the modulation of the beam offers several advantages:
This configuration is not very sensitive to beam/wire alignment defects. Even if the wire is slightly offset, the beam will still be able to melt it with the same efficiency.
It becomes possible to use several simultaneous wire injections (6, 16, 26), in the modulation of the focused beam and making it possible to melt all these wires at the same time in order to supply a single molten pool.

This use of several fused wires simultaneously and a controlled modulation of the laser beam (9) results in several advantages:
Keeping the filler wire in the interaction of the laser beam requires a less fine adjustment than with a fixed beam, making it possible to reinforce the operating flexibility of the method; and
Allowing the use of several filler wires simultaneously in the interaction of the laser beam to increase the construction speed.

In the case where a multiple filler wire is used, a “comb” composed of several wires (6, 16, 26) can be controlled individually so as to select the desired wires in the interaction in order to modify the morphology of the deposit during the use of the method: for example, in the case of side-by-side beads, especially when the beads are wide, and in order to ensure better surface geometry.

The comb consisting of several injections of wires may be composed of wires of different diameters to more precisely control the melting of the filler metal along the edges or the center of the pool, and based on the modulation parameters.

These simultaneous injections can use different natures of metal wire, making it possible to vary the chemical compositions by adjusting the injection rates of each wire. It then becomes possible to produce material gradients during the construction and with great reactivity. Indeed, this technique is also possible with the DED-powder method (example CLAD®), but it suffers from an inertia due to the transport of the powder in the pipes, limiting the variations in composition during the production of a bead. This limitation is lifted by using differential injection of the wires.

The modulation of the beam on the wire(s) also allows the use of cored wires, which makes it possible to work with wires having the composition suitable for the method, for example, allowing reinforcement of certain alloying elements in the event of volatilization during the interaction with the beam but also an extended range of possibilities of usable wires, with, for example, non-cross-linkable materials.

Controlling the movements of the modulation allows improved regularity and stability of the molten pool and makes it possible to vary the width of the molten pool by adjusting the modulation amplitude as well as the height of the molten pool based on the modulation parameters of the speed of travel along the main path.

Depending on the position of the wire in the modulation design, the part of the beam that is not absorbed by the wire preheats the workpiece or the preceding layer upstream of the molten pool.

The work with a large focal length offers the advantage of working with a large depth of field. This depth of field provides great operating flexibility along the Z axis: the characteristics of the beam change little over a large range, thus making it possible to preserve the performance for the melting of the wire and its deposition on the preceding layer. This is an important point because in this case, profile variations will have only a limited influence on the characteristics of the deposit.

Finally, this configuration has the advantage of completely freeing the zone of interaction, thus making it possible to:
Use sensors to track the interaction, measure the deposits in real time, and without the sensors being too close to the interaction, thus moving them away from the pollution sources (projections, fumes, etc.);
Move the focusing optics away and thus have the space to implement effective protection means to guarantee their lifetime. Furthermore, these protection means are often based on an air gap, which can disrupt the quality of the gas protection of the deposited bead;
Install effective suction means for the flue gases emitted; and
Have an ideal limited bulk to reach hard-to-access zones, for example, in the case of complicated geometries or workpieces requiring many clamping means.

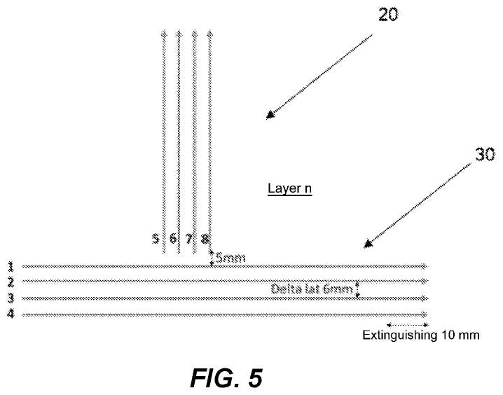

FIG. 5 shows the implementation of the present disclosure for the additive manufacturing of a test specimen having a “T”-shaped cross section. The horizontal arrows (30) depict the main paths to form a layer of one of the bars of the test specimen, with the deposition order number, and the vertical arrows (20) depict the main paths to form a layer of the other bar of the test specimen.

The features of the installation according to the present disclosure, for this embodiment but also for other configurations of workpieces to be manufactured, are as follows:
Material: INCONEL® 625
Construction rate 505 cm³/h
Laser power used: 7500 W
Speed of paths: 0.5 m/min
Unwinding speed of the wire: 4.2 m/min
Wire diameter used: 1.6 mm
Filler wire angle: 59°
Free length of wire: 20 mm
Beam incidence angle: Normal to surface
Layer height: 2.2 mm
Bead width: 12 mm
Lateral offset between beads: 6.4 mm
Modulation design: Figure eight
Modulation amplitude: 6 mm
Modulation frequency: 250 Hz

For the example disclosed, the dimensions of the test specimen are:
a. Height: 80 mm
b. Wall length: 250 mm
c. Walls thickness: 30 mm

The main path comprises parallel movements (20), in the disclosed example a first rectilinear movement in one direction, over a distance of 220 millimeters, then a movement offset in the perpendicular direction, by a pitch of 6.4 mm and a return in the opposite direction, the beam turned off, of 220 millimeters, and reiteration to cover the width of the branch being produced.

Then, the layer of the complementary branch is made, with equivalent cycles, with a spacing of 5 mm.

Then, the deposition head is shifted by an increment of 2.2 m in the direction normal to the surface of the deposited layer to manufacture the following layer, with the same kinematics, but starting the first line on the side opposite the first line of the preceding layer, and laterally shifting in the opposite direction, so that the material deposition order is of the type “1 to 4” for one layer and “4 to 1” for the following layer.

The method must thus allow the manufacture of large workpieces, at manufacturing speeds greater than 500 cm³/h. This device must make it possible to maintain a regularity of deposition layer after layer owing to high robustness, despite the high speed of construction that can be achieved.

The present disclosure makes it possible to meet the following constraints:
Allow high construction speed (greater than 500 cm³/h);
Make workpieces of large dimensions (up to several meters in length and several meters in height and width) owing to a stack of successive beads;
Make the method very stable with a high reproducibility of the deposited beads and their dimensions;
Enable monitoring and oversight of the method by integrating optical and non-optical sensors;
Make the method robust and tolerant, making it possible to deposit numerous layers without any intervention;
Have excellent management of thermal aspects in order to be able to consider constructions over very long periods of time (several days), and by limiting the stops as much as possible;
Limit focus and adjustment constraints;
Limit system bulk in zone of interaction;
Allow adaptation of a multiple wire injection system;
Allow the use of wire with diameters of between 0.8 mm and 3.2 mm;
Limit the number of consumables related to the use of the method;.
Make the method easy to automate;
Allow the method to be mounted on a robotic system; and
Be able to use laser power levels up to more than 10 KW.

### MULTI-WIRE INJECTION

It is advantageous to inject two or more wires into the zone of interaction in order to be able to melt more material with the same swept beam. This makes it possible to increase the construction speed; moreover, using 2 wires at the same time allows lower wire feed speeds than with a single wire and better control thereof, but also allows the contribution of material to be spread over the width of the molten pool, which provides better stability to the method, and finally this allows better use of the energy provided by the beam by optimizing the ratio between the total swept area and the interaction surface between the beam and the wires, while preserving the creation and maintenance of the molten pool.

### INJECTION OF FILLER WIRES OF DIFFERENT NATURES

By injecting various filler wires with different chemical compositions, it is possible to act on the chemistry of molten zone. Thus, by adjusting the feed speeds of each of the wires, it becomes possible to vary the chemical composition of the molten zone and thus to create composition gradients and, as a result, properties directly during the construction of the workpiece.

By injecting wires of different diameters so as to provide suitable quantities of material in each part of the molten pool. Thus, with 3 wires, wires of larger diameters can be provided on the edges of the molten zone to offset the sinking of the material and the cusps where the beam remains for longer, and a wire of smaller diameter at the center of the molten zone where the passage speeds of the beam are greatest.

### OPTIONAL VARIANT

One variant consists in modifying the control in real time to adapt the modulation design to particular requirements: several wires, change of the geometry of the deposited bead.

In particular, the possibility of adapting the modulation design of the laser beam to the various injected wires makes it possible to optimize the efficiency of the coupling and thus to better control the melting thereof, while ensuring the preheating of the workpiece upstream of the molten pool.

In the event several filler wires are implemented, a specific injector is used to guide the various wires in the zone of interaction according to the desired angles. This injector comprises a body efficiently cooled by a water circuit, and interchangeable tips called “contact tubes” screwed into this body, which allow the wires to be injected as close as possible to the zone of interaction.

The present disclosure also relates to additive printing equipment operating according to this method.

1. An additive manufacturing method, comprising:
commanding movement of an equipment item comprising at least one laser across a surface of a workpiece being manufactured, a beam of the at least one laser being focused on an outlet of a supply head delivering at least one metallic wire of diameter D,
causing the equipment item to move a zone of interaction of the beam of the at least one laser with the at least one wire along a main path representative of a geometry of the workpiece being manufactured;
modulating movement of the zone of interaction by 2-axis modulation in a longitudinal direction parallel to a speed vector of the main path and a transverse direction normal to the speed vector in a focal plane, deviation of the zone of interaction resulting from the modulation defining a curve swept at a speed greater than a speed of travel along the main path;
wherein the deviation resulting from the modulation is not constant, but depends upon a position on the main path; and
wherein the modulation is:
a. either defined beforehand for each zone of the main path, modifications of sweeping parameters being controlled based on a position of the at least one laser on the main path;
b. or dynamically controlled by controlling changes in the sweeping parameters responsive to information provided by a sensor directed toward the zone of interaction of the laser with the at least one wire.

2. The method of claim 1, wherein parameters of the modulation are determined based on local characteristics of the path, including:
a nature of a design of the workpiece being manufactured;
an amplitude of the modulation;
a frequency of the modulation; and
dimensions of the design of the workpiece being manufactured.

3. The method of claim 1, wherein modulating movement of the zone of interaction includes accounting for at least one local characteristic while controlling the modulation, the at least one local characteristic selected from among the group consisting of:
a direction of movement relative to the at least one wire;
a geometry of the main path;
a radius of curvature of the main path;
a type of bead;
a zone of the bead; or
a speed variation of the main path.

4. The method of claim 2, wherein parameters of various designs are identified beforehand and stored in a database and selected based on variations of characteristics of the material deposition during the movement along the main path.

5. The method of claim 2, wherein parameters of various designs are identified beforehand and stored in a database and selected based on automatic analysis in real time of conditions of the interaction and of the deposition geometry to adapt the modulation parameters.

6. The method of claim 2, wherein parameters of various designs applied during the method are calculated in real-time using algorithms based on the automatic analysis in real time of the conditions of the interaction and of the deposition geometry in order to adapt the modulation parameters.

7. The method of claim 1, wherein an axis of the supply head forms an angle between 5° and 40° with an axis of the laser beam.

8. The method of claim 1, wherein the supply head comprises a plurality of wire outlets converging toward the zone of interaction.

9. The method claim 1, wherein at least two wires are injected into the zone of interaction.

10. The method of claim 1, further comprising using a control system to control the modulating of the movement of the zone of interaction and delivering of the at least one metallic wire from the outlet of the supply head.

11. The method of claim 1, wherein the at least one metal wire comprises at least two different materials.

12. The method of claim 1, further comprising preheating material upstream from a molten pool formed within the zone of interaction using a beam not absorbed by the wires.

13. The method of claim 1, wherein the movement of the zone of interaction is modulated by the modulation according to a shape adapted to the injection of the at least one wire so as to ensure preheating of a zone comprising the at least one wire and the workpiece upstream of a molten pool in the zone of interaction, melting of the at least one wire, and maintenance of the molten pool.

14. The method of claim 1, wherein the movement of the zone of interaction is modulated by the 2-axis modulation according to a shape determined to act directly during deposition of material over a width of a molten pool in the zone of interaction, and geometric characteristics of deposited material.

15. The method of claim 1, wherein at least one wire comprises at least two wires, and wherein the method further comprises independently varying a feed speed of each of the at least two wires to vary a chemical composition of a molten pool in the zone of interaction.

16. The method of claim 1, wherein the at least one wire comprises at least two wires of different diameters, wherein the method further comprises injecting the at least two wires into a molten pool in the zone of interaction.

17. An additive manufacturing equipment item, comprising at least one laser, a beam of which is focused on an outlet of a supply head that delivers at least one metallic wire of diameter D, the equipment item being controlled by a control system to move a zone of interaction of the beam of the laser with the at least one wire along a main path representative of a geometry of a workpiece being manufactured, the equipment item further comprising means for controlling movement of the zone of interaction with a 2-axis modulation in a longitudinal direction parallel to a speed vector of the main path and a transverse direction normal to the speed vector in a focal plane, the modulation resulting in a deviation defining a curve swept at a speed greater than a speed of travel along the main path, parameters of the 2-axis modulation being determined dynamically by the control system.
